(19) United States
(12) Patent Application Publication
(10) Pub. No.: US 2024/0429970 A1
(43) Pub. Date: Dec. 26, 2024

(54) METHOD AND APPARATUS FOR SIGNAL CONVERSION USING REFLECTION MAGNITUDE AND REFLECTION PHASE

(71) Applicant: ELECTRONICS AND TELECOMMUNICATIONS RESEARCH INSTITUTE, Daejeon (KR)

(72) Inventors: Dongho KIM, Daejeon (KR); Seung Keun PARK, Daejeon (KR); Sang il KWAK, Daejeon (KR); Hyeyeon KWON, Daejeon (KR); Dong-Uk SIM, Daejeon (KR); jeongwoo HUR, Daejeon (KR); seong ju KIM, Daejeon (KR); Hanjun MAENG, Daejeon (KR)

(21) Appl. No.: 18/679,853

(22) Filed: May 31, 2024

(30) Foreign Application Priority Data
Jun. 26, 2023 (KR) 10-2023-0081850

(51) Int. Cl. H04B 7/04; H04B 7/06

(52) U.S. Cl. CPC H04B 7/04013; H04B 7/0634

(57) ABSTRACT

A signal conversion method and device for generating a modulation signal are provided. The signal conversion method includes receiving an input signal and a reflection coefficient of a reconfigurable intelligent surface (RIS) according to a sample time, selecting an optimized reflection coefficient of the RIS corresponding to the sample time, and generating the modulation signal by applying the optimized reflection coefficient of the RIS to the input signal.

### CROSS-REFERENCE TO RELATED APPLICATION

This application claims the benefit of Korean Patent Application No. 10-2023-0081850 filed on Jun. 26, 2023, in the Korean Intellectual Property Office, the entire disclosure of which is incorporated herein by reference for all purposes.

### BACKGROUND

### 1. Field of the Invention

One or more embodiments relate to signal conversion technology using a reflection magnitude and a reflection phase.

### 2. Description of the Related Art

Reconfigurable intelligent surface (RIS) technology, which aims to tune a signal at a specific location by controlling a phase shift of the signal, is technology related to a planar surface composed of a large number of sub-wavelength elements capable of reflecting, scattering, and manipulating an electromagnetic wave. Various research is being conducted to improve signal conversion performance using RIS technology in various industrial fields such as military and defense.

### SUMMARY

According to an aspect, there is provided a signal conversion method including receiving an input signal and a reflection coefficient of a reconfigurable intelligent surface (RIS) according to a sample time, selecting an optimized reflection coefficient of the RIS corresponding to the sample time, and generating the modulation signal by applying the optimized reflection coefficient of the RIS to the input signal.

The selecting of the optimized reflection coefficient of the RIS may comprise generating a random entity population for the reflection coefficient of the RIS and selecting, from among reflection coefficients of the RIS in the random entity population, a reflection coefficient entity having a highest similarity to a frequency of a target signal when the reflection coefficient of the RIS is applied to the input signal at the sample time, determining whether the selected reflection coefficient entity of the RIS satisfies a threshold value, and selecting the reflection coefficient of the RIS optimized for the sample time based on the selected reflection coefficient entity of the RIS, when the selected reflection coefficient entity of the RIS satisfies the threshold value.

When the selected reflection coefficient entity of the RIS does not satisfy the threshold value, the selecting of the optimized reflection coefficient of the RIS may further include crossing reflection coefficient entities of the RIS in the random entity population, generating a new entity population through generating a mutant entity of an entity of the reflection coefficients of the RIS in the random entity population, and selecting, from among reflection coefficients of the RIS in the new entity population, an entity having a highest similarity to the frequency of the target signal, when the reflection coefficient of the RIS is applied to the input signal.

The reflection coefficient entity of the RIS may include information on a reflection magnitude coefficient of the modulation signal at the sample time and a reflection phase coefficient of the modulation signal at the sample time.

The selecting of the optimized reflection coefficient of the RIS may include selecting the reflection coefficient of the RIS optimized for the sample time based on a look-up table.

According to an aspect, there is provided a signal conversion device that generates a modulation signal, the signal conversion device including a processor, at least one memory configured to store instructions to be executed by the processor, and a communication module comprising an RIS including a plurality of unit cells, of which a reflection characteristic is variable, arranged horizontally or vertically, wherein, when the instructions are executed by the processor, the processor is configured to receive an input signal and a reflection coefficient of a reconfigurable intelligent surface (RIS) according to a sample time, select a reflection coefficient of the RIS optimized for the sample time, and generate the modulation signal by applying the selected reflection coefficient of the RIS to the input signal.

The processor may be further configured to generate a random entity population for the reflection coefficient of the RIS and select, from among reflection coefficients of the RIS in the random entity population, a reflection coefficient entity having a highest similarity to a frequency of a target signal when the reflection coefficient of the RIS is applied to the input signal at the sample time, determine whether the selected reflection coefficient entity of the RIS satisfies a threshold value, and select the reflection coefficient of the RIS optimized for the sample time based on the selected reflection coefficient entity of the RIS, when the selected reflection coefficient entity of the RIS satisfies the threshold value.

The processor may be further configured to repeat, when the selected reflection coefficient entity of the RIS does not satisfy the threshold value, crossing reflection coefficient entities of the RIS in the random entity population, generating a new entity population through generating a mutant entity of an entity of the reflection coefficients of the RIS in the random entity population, and selecting, from among reflection coefficients of the RIS in the new entity population, an entity having a highest similarity to the frequency of the target signal, when the reflection coefficient of the RIS is applied to the input signal.

The reflection coefficient entity of the RIS may include information on a reflection magnitude coefficient of the modulation signal at the sample time and a reflection phase coefficient of the modulation signal at the sample time.

The processor may be further configured to select the reflection coefficient of the RIS optimized for the sample time based on a look-up table.

According to an aspect, there is provided a cell including a first conductive layer, a first dielectric substrate positioned at a lower end of the first conductive layer, a second conductive layer positioned below the first dielectric substrate, a second dielectric substrate positioned at a lower end of the second conductive layer, and a conductor positioned at a lower end of the second dielectric substrate, wherein the first conductive layer includes a 1-1 conductor including a first diode and a first capacitor and arranged in a first direction and a 1-2 conductor arranged in a second direction perpendicular to the first direction, wherein the 1-1 conductor and the 1-2 conductor are configured to be connected through first inductors, and wherein the second conductive layer includes a 2-1 conductor including a second diode and a second capacitor and arranged in the first direction and a 2-2 conductor arranged in the second direction perpendicular to the first direction, wherein the 2-1 conductor and the 2-2 conductor are configured to be connected through second inductors.

A pattern of the second conductive layer may be identical to a pattern of the first conductive layer.

A capacitance of the second capacitor included in the second conductive layer may be different from a capacitance of the first capacitor included in the first conductive layer.

Voltage applied to the second diode included in the second conductive layer may be different from voltage applied to the first diode included in the first conductive layer.

A capacitance of the first diode may change depending on voltage applied to the first diode.

A capacitance of the second diode may change depending on voltage applied to the second diode.

According to an aspect, there is provided an RIS including a plurality of cells arranged horizontally or vertically, wherein the cell includes a first conductive layer, a first dielectric substrate positioned at a lower end of the first conductive layer, a second conductive layer positioned below the first dielectric substrate, a second dielectric substrate positioned at a lower end of the second conductive layer, and a conductor positioned at a lower end of the second dielectric substrate, wherein the first conductive layer includes a 1-1 conductor including a first diode and a first capacitor and arranged in a first direction and a 1-2 conductor arranged in a second direction perpendicular to the first direction, wherein the 1-1 conductor and the 1-2 conductor are configured to be connected through first inductors, and wherein the second conductive layer includes a 2-1 conductor comprising a second diode and a second capacitor and arranged in the first direction and a 2-2 conductor arranged in the second direction perpendicular to the first direction, wherein the 2-1 conductor and the 2-2 conductor are configured to be connected through second inductors.

A pattern of the second conductive layer may be identical to a pattern of the first conductive layer.

A capacitance of the second capacitor included in the second conductive layer may be different from a capacitance of the first capacitor included in the first conductive layer.

A reflection coefficient of the RIS may include information on a reflection magnitude coefficient of a modulation signal and a reflection phase coefficient of the modulating signal.

Additional aspects of embodiments will be set forth in part in the description which follows and, in part, will be apparent from the description, or may be learned by practice of the disclosure.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIGS. 1A and 1B are diagrams schematically illustrating a frequency conversion environment according to an embodiment;

FIGS. 2A and 2B are flowcharts illustrating a signal conversion method using a reflection magnitude and a reflection phase, according to an embodiment;

FIGS. 3A and 3B are diagrams illustrating a unit cell of a reconfigurable intelligent surface (RIS) of which a reflection characteristic is electrically variable, according to an embodiment;

FIG. 4 is a diagram illustrating an RIS including a plurality of unit cells, according to an embodiment;

FIGS. 5A and 5B are diagrams illustrating a change in a reflection coefficient according to a change in a capacitance value, according to an embodiment;

FIGS. 6A and 6B are diagrams illustrating a modulation signal at a sample time, according to an embodiment;

FIG. 7 is a block diagram illustrating a configuration of a signal conversion device that performs a signal conversion method, according to an embodiment.

### DETAILED DESCRIPTION

The following structural or functional description of examples is provided as an example only and various alterations and modifications may be made to the examples. Thus, an actual form of implementation is not construed as limited to the examples described herein and should be understood to include all changes, equivalents, and replacements within the idea and the technical scope of the disclosure.

Although terms such as first, second, and the like are used to describe various components, the components are not limited to the terms. These terms should be used only to distinguish one component from another component. For example, a “first” component may be referred to as a “second” component, and similarly, the “second” component may also be referred to as the “first” component.

It should be noted that when one component is described as being “connected,” “coupled,” or “joined” to another component, the first component may be directly connected, coupled, or joined to the second component, or a third component may be “connected,” “coupled,” or “joined” between the first and second components.

The singular forms “a,” “an,” and “the” are intended to include the plural forms as well, unless the context clearly indicates otherwise. It will be further understood that the terms “comprises/comprising” and/or “includes/including,” when used herein, specify the presence of stated features, integers, steps, operations, elements, and/or components, but do not preclude the presence or addition of one or more other features, integers, steps, operations, elements, components and/or groups thereof.

Unless otherwise defined, all terms used herein including technical and scientific terms have the same meanings as those commonly understood by one of ordinary skill in the art to which this disclosure pertains. Terms such as those defined in commonly used dictionaries are to be interpreted as having a meaning that is consistent with their meaning in the context of the relevant art and are not to be interpreted in an idealized or overly formal sense unless expressly so defined herein.

Hereinafter, the examples are described in detail with reference to the accompanying drawings. When describing the examples with reference to the accompanying drawings, like reference numerals refer to like components and a repeated description related thereto is omitted.

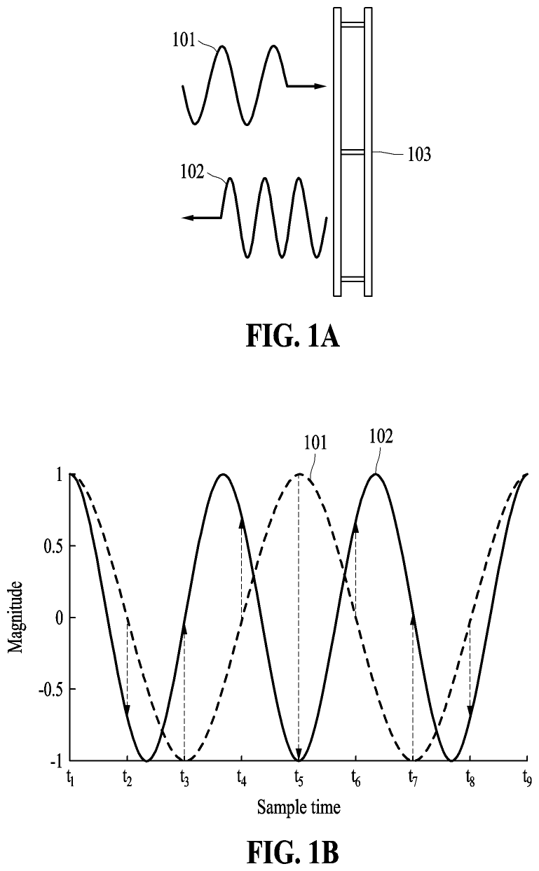

FIGS. 1A and 1A are diagrams schematically illustrating a frequency conversion environment according to an embodiment.

An input signal reaching a reconfigurable intelligent surface (RIS) may be modulated as the input signal is reflected/transmitted through the RIS. A magnitude and a direction of a modulated signal, polarization of the modulated signal, and a frequency of the modulated signal may be reconfigured by controlling a reflection/transmission characteristic of the RIS, wherein the modulated signal may be obtained as an incident signal is reflected/transmitted through the RIS. In addition, when values of resistance, an inductor, and a capacitor element in the RIS may be controlled using a voltage and a current, the reflection/transmission characteristic of the RIS may be electrically changed through electrical control, for example, using an element such as a PIN diode and a varactor diode.

Since a frequency of a reflected modulation signal may be modulated and a signal may be encoded by linearly changing a reflection coefficient of the RIS over time, an electromagnetic wave may be manipulated and a Doppler frequency shift may be artificially implemented by utilizing the RIS to simulate a Doppler frequency shift environment, which occurs due to high-speed movement when measuring a signal. This may be used for, for example, radar detection evasion and deception in a variety of application fields such as military and defense.

An indicator of frequency conversion performance may include conversion loss and spurious-free dynamic range (SFDR). Conversion loss may refer to a difference between a magnitude of an existing frequency component of the input signal and a magnitude of a frequency component of a target signal. SFDR may refer to an operating band without spurious, for example, a power operating range (or a dynamic range) in a state in which two signals (e.g., an input signal and a modulation signal) exist and a third intermodulation component is suppressed to a degree of a noise level. In other words, in order to improve frequency conversion performance during frequency conversion, it may be important to minimize conversion loss and maximize a dynamic range that may be effectively controlled by a system. In this regard, in order to obtain a desired target signal, a Doppler frequency shift needs to be implemented considering not only a reflection phase of the RIS over time but also a reflection magnitude and the reflection phase of the RIS. Frequency conversion technology has a potential to improve performance of a wireless communication system in various scenarios, such as an indoor environment in which a signal may be reflected and interfered with, and research related to this is being conducted to meet this demand.

Referring to FIGS. 1A and 1B, an input signal 101 incident on an RIS 103 may be reflected by the RIS 103 and become a modulation signal 102. Here, the principle by which the input signal 101 becomes the modulation signal 102 may be expressed as Equation 1 below.

$${E}_{r} = {E}_{0} \vert Γ \vert cos ( {ω}_{i} {t}_{n} + ∠Γ ) = {E}_{0} \vert Γ ( t ) \vert cos ( ( {ω}_{i} + {ω}_{d} ) {t}_{n} ) \qquad [ Equation 1 ]$$

Here, Eᵣ denotes the modulation signal 102, E₀ denotes a size of the input signal 101, Γ denotes a reflection coefficient of the RIS 103, ωᵢ denotes each frequency of the input signal 101, ω_{d} denotes each frequency of the modulation signal 102, and tₙ denotes an n-th sample time. That is, as in Equation 1, when the input signal 101 is reflected by the RIS 103, a size and each frequency of the modulation signal 102 may change every sample time by a reflection magnitude and a reflection phase of the reflection coefficient of the RIS 103. That is, the input signal 101 may be sampled according to the sample time, and the modulation signal 102 may be matched to the target signal or a reflection magnitude and a reflection phase, by which the modulation signal 102 may be similar to the target signal, may be obtained by considering a difference between the modulation signal 102 and the target signal at each sampling point. When the obtained reflection magnitude and reflection phase are matched to each sample time, conversion loss may be minimized and SFDR may be maximized.

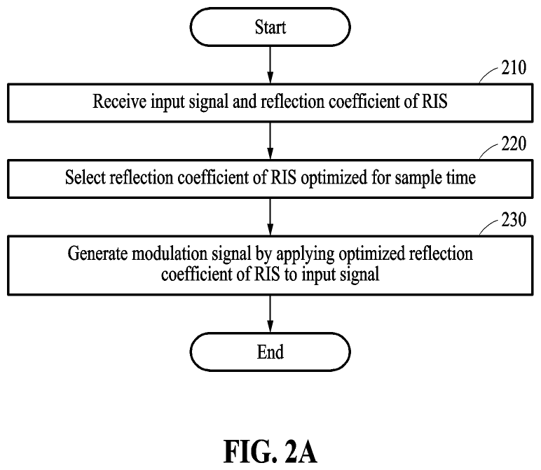

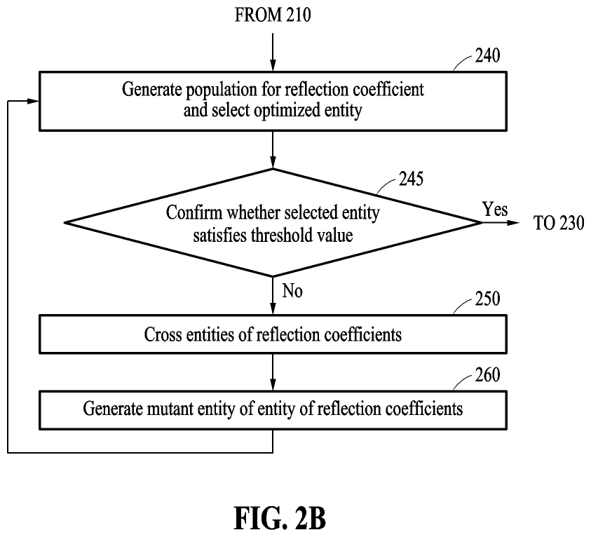

FIGS. 2A and 2B are flowcharts illustrating a signal conversion method using a reflection magnitude and a reflection phase, according to an embodiment.

Referring to FIG. 2A, the signal conversion method may include operation 210 of receiving an input signal and a reflection coefficient of an RIS. In an embodiment, the reflection coefficient of the RIS may include, for example, information on a reflection magnitude coefficient of a modulation signal at a sample time and a reflection phase coefficient of the modulation signal at the sample time when an input signal is converted to the modulation signal, as described with reference to FIGS. 1A and 1B.

The signal conversion method may include operation 220 of selecting a reflection coefficient of an RIS optimized for a sample time. Operation 220 of selecting a reflection coefficient of an RIS optimized for a sample time may include selecting a reflection coefficient of an RIS optimized for a sample time based on a look-up table. The look-up table may be a predetermined table including information on a reflection magnitude and a reflection phase that an RIS may provide. Operation 220 of selecting a reflection coefficient of an RIS optimized for a sample time may include an operation of selecting a reflection coefficient of an RIS optimized for a sample time according to an optimization algorithm (e.g., a genetic algorithm), which is described in detail with reference to FIG. 2B.

The signal conversion method may include operation 230 of generating a modulation signal by applying an optimized reflection coefficient of an RIS to an input signal. Operation 230 of generating a modulation signal may include generating a modulation signal by obtaining a reflection coefficient and a reflection phase that make a modulation signal similar to a target signal, or by matching a modulation signal to a target signal by applying the optimized reflection coefficient of an RIS to an input signal.

Referring to FIG. 2B, the operation of selecting a reflection coefficient of an RIS optimized for a sample time according to a genetic algorithm may be confirmed. A genetic algorithm is a type of an optimization algorithm that imitates the genetics and evolution of living things and may refer to an algorithm that proceeds with a next optimization based on an excellent entity among current results when performing optimization. A progression sequence of a genetic algorithm may include selecting a most excellent entity in the present, crossing entities to generate an entity to be used for next optimization, and performing a mutation to generate a new entity population for an evolution in a different direction.

Operation 220 of selecting the optimized reflection coefficient of the RIS may include operation 240 of generating a population for the reflection coefficient and selecting an optimized entity. A reflection coefficient entity of the RIS may include the information on the reflection magnitude coefficient of the modulation signal at the sample time and the reflection phase coefficient of the modulation signal at the sample time.

Operation 240 of selecting an optimized entity may include generating a random entity population for a reflection coefficient of an RIS and selecting, from among reflection coefficients of the RIS in the random entity population, an entity having a highest similarity to a frequency of the target signal when the reflection coefficient of the RIS is applied to the input signal at the sample time.

Operation 220 of selecting the optimized reflection coefficient of the RIS may include operation 245 of confirming whether a selected entity satisfies a threshold value. Operation 245 of confirming whether a selected entity satisfies a threshold value may include confirming whether a similarity with the target signal satisfies the threshold value when the reflection coefficient is applied to the input signal at the sample time. Operation 220 of selecting the optimized reflection coefficient of the RIS may include an operation of selecting a reflection coefficient of an RIS optimized for a sample time based on a selected reflection coefficient entity of the RIS, when the selected entity satisfies the threshold value. Operation 220 of selecting the optimized reflection coefficient of the RIS may further include, when the selected reflection coefficient entity of the RIS does not satisfy the threshold value, operation 250 of crossing entities of reflection coefficients of the RIS in the random entity population, an operation of generating a new entity population through operation 260 of generating a mutant entity of an entity of the reflection coefficients of the RIS in the random entity population, and repeating an operation of selecting, from among reflection coefficients entities of the RIS in the new entity population, an entity having the highest similarity to the frequency of the target signal, when the reflection coefficient of the RIS is applied to the input signal. Operation 250 of crossing entities of reflection coefficients of the RIS may include an operation of generating a new entity by crossing over information between different entities. Operation 260 of generating a mutant entity of an entity of the reflection coefficients of the RIS may include an operation of generating a mutant entity when information between entities generated through crossing is modified. The repeating of the operation of selecting, from among reflection coefficients of the RIS in the new entity population, the entity having the highest similarity to the frequency of the target signal when a reflection coefficient of an RIS is applied to the input signal may include operations 240 to 260 stated above.

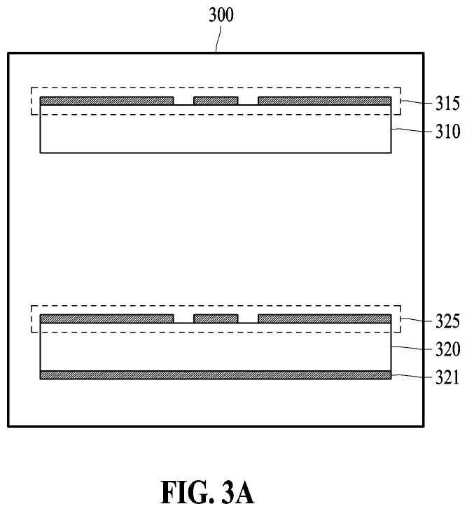

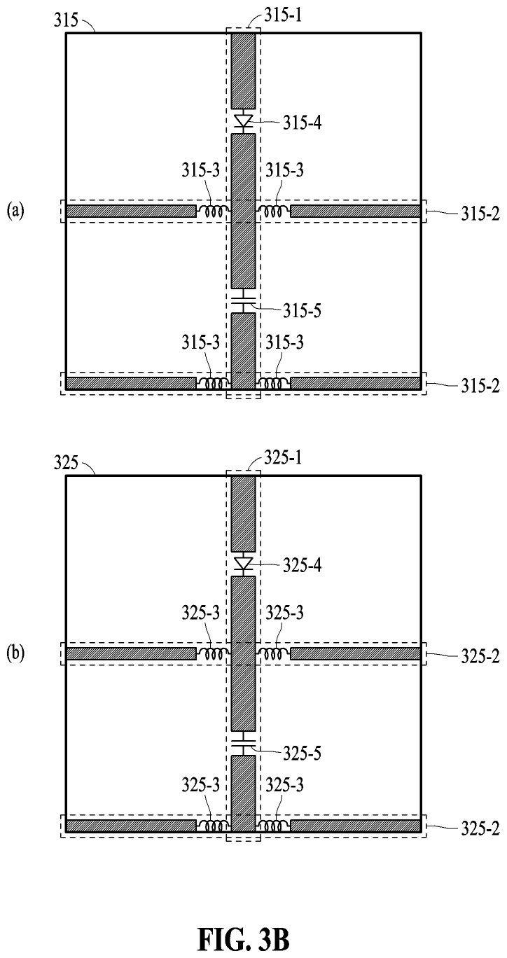

FIGS. 3A and 3B are diagrams illustrating a unit cell of an RIS of which a reflection characteristic is electrically variable, according to an embodiment.

Referring to FIG. 3A, a structure of a unit cell 300 of an RIS, of which a reflection characteristic is electrically variable, according to an embodiment, is shown.

The unit cell 300 of an RIS may include a first conductive layer 315, a first dielectric substrate 310 positioned at a lower end of the first conductive layer 315, a second conductive layer 325 positioned below the first dielectric substrate 310, a second dielectric substrate 320 positioned at a lower end of the second conductive layer 325, and a conductor 321 positioned at a lower end of the second dielectric substrate 320. For example, the unit cell 300 of an RIS may include the first dielectric substrate 310 and the second dielectric substrate 320 positioned below the first dielectric substrate 310. The first conductive layer 315 may be positioned on the first dielectric substrate 310 included in the unit cell 300 of an RIS, the second conductive layer 325 may be positioned on the second dielectric substrate 320, and an entire lower end of the second dielectric substrate 320 may be covered with the conductor 321. The first dielectric substrate 310 and the second dielectric substrate 320 may be positioned at the lower end of the first conductive layer 315 and the second conductive layer 325, respectively, to function as an insulator in a device such as a printed circuit board (PCB) and a microstrip antenna, or to prevent electrical shorts and reduce signal interference, and may generally include a material such as glass fiber, ceramic, or plastic.

Referring to FIG. 3B, a structure of the first conductive layer 315 and the second conductive layer 325 included in the unit cell 300 of an RIS, of which a reflection characteristic is electrically variable, according to an embodiment, is shown.

The first conductive layer 315 may include a 1-1 conductor 315-1 that includes a first diode 315-4 and a first capacitor 315-5 and that is arranged in a first direction, and a 1-2 conductor 315-2 arranged in a second direction perpendicular to the first direction, wherein the 1-1 conductor 315-1 and the 1-2 conductor 315-2 may be connected to each other through first inductors 315-3. In an embodiment, the first diode 315-4 and the first capacitor 315-5 may be connected in series, and the first capacitor 315-5 may be a chip capacitor. However, embodiments according to the present disclosure are not limited thereto.

The second conductive layer 325 may include a 2-1 conductor 325-1 that includes a second diode 325-4 and a second capacitor 325-5 and that is arranged in the first direction, and a 2-2 conductor 325-2 arranged in the second direction perpendicular to the first direction, wherein the 2-1 conductor 325-1 and the 2-2 conductor 325-2 may be connected to each other through second inductors 325-3. In an embodiment, the second diode 325-4 and the second capacitor 325-5 may be connected in series, and the second capacitor 325-5 may be a chip capacitor. However, embodiments according to the present disclosure are not limited thereto.

In embodiment, a pattern of the second conductive layer 325 may be identical to a pattern of the first conductive layer 315. In an embodiment, a capacitance of the second capacitor 325-5 included in the second conductive layer 325 may be different from a capacitance of the first capacitor 315-5 included in the first conductive layer 315. In embodiment, voltage applied to the second diode 325-4 included in the second conductive layer 325 may be different from voltage applied to the first diode 315-4 included in the first conductive layer 315.

In an embodiment, a capacitance of the first diode 315-4 may change depending on the voltage applied to the first diode 315-4, and a capacitance of the second diode 325-4 may change depending on the voltage applied to the second diode 325-4. In an embodiment, the first diode 315-4 and the second diode 325-4 may be varactor diodes, and the voltage applied to the first diode 315-4 may be different from the voltage applied to the second diode 325-4.

In an embodiment, a reflection coefficient of the unit cell 300 of an RIS may change according to capacitance values of the first diode 315-4 and the second diode 325-4, which may change depending on the voltages applied to the first diode 315-4 and the second diode 325-4.

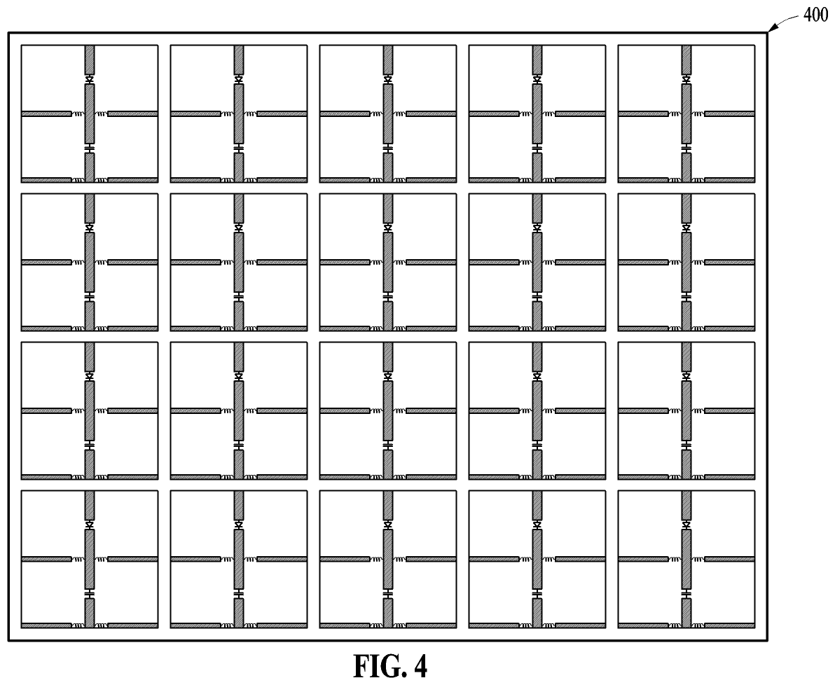

FIG. 4 is a diagram illustrating an RIS including a plurality of unit cells, according to an embodiment.

Referring to FIG. 4, an RIS 400 may include a plurality of cells arranged horizontally or vertically, and a cell may include a configuration identical or similar to the configuration described with reference to FIGS. 3A and 3B. The plurality of cells included in the RIS 400 may include a first conductive layer and a second conductive layer as described above, and a pattern of the second conductive layer may be identical to a pattern of the first conductive layer. The plurality of cells included in the RIS 400 may include a first capacitor and a second capacitor as described above, and a capacitance of the second capacitor may be different from a capacitance of the first capacitor. A reflection coefficient of the RIS 400 may include information on a reflection magnitude coefficient of a modulation signal and a reflection phase coefficient of the modulation signal. However, embodiments according to the present disclosure are not limited to the forms described above.

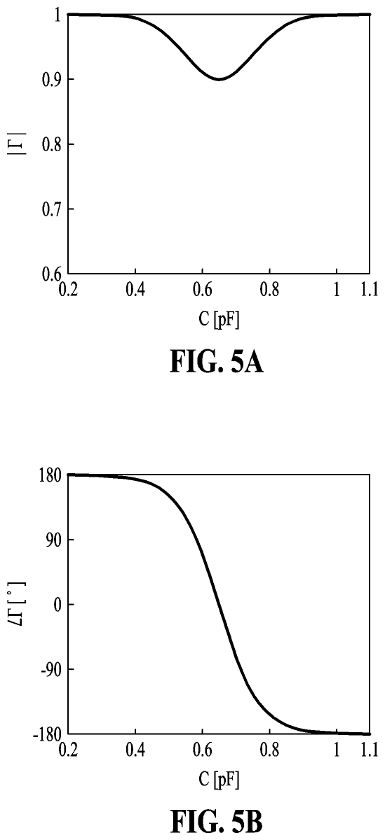

FIGS. 5A and 5B are diagrams illustrating a change in a reflection coefficient according to a change in a capacitance value, according to an embodiment.

Referring to FIG. 5A, a change in the reflection magnitude coefficient of the modulation signal according to the change in the capacitance value of an RIS is shown. Referring to FIG. 5B, a change in the reflection phase coefficient of the modulation signal according to the change in the capacitance value of the RIS is shown. In an embodiment, the reflection phase coefficient that may be provided by the RIS may provide a reflection phase greater than or equal to 360 degrees for maximization of SFDR.

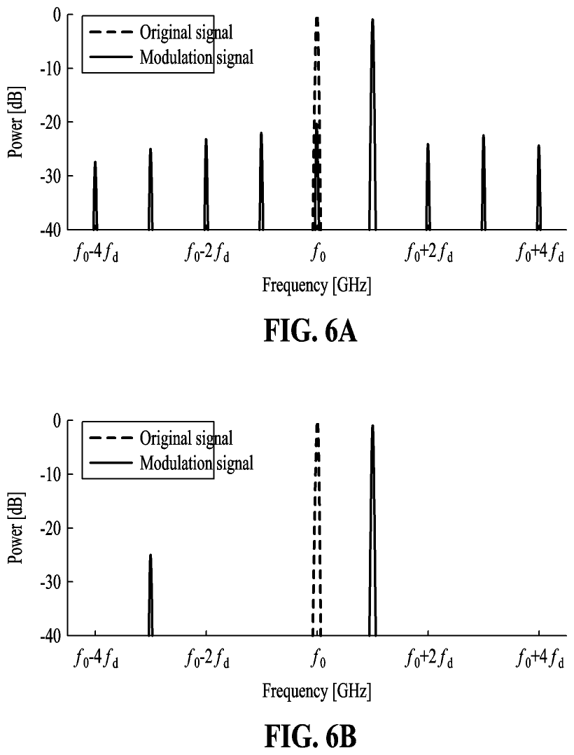

FIGS. 6B and 6B are diagrams illustrating a modulation signal at a sample time, according to an embodiment.

FIG. 6A is a graph to explain power according to a frequency for a result of Fourier transforming a conventional Doppler frequency shifted reflected wave, and FIG. 6B is a graph to explain a result of a signal conversion method according to an embodiment. Comparing a shape of the modulation signal to a shape of an original signal in FIGS. 6A and 6B, when converting a signal according to the signal conversion method, it may be confirmed that conversion of the signal to an undesired frequency component occurs less often than in the prior art, and accordingly, conversion loss and SFDR increase.

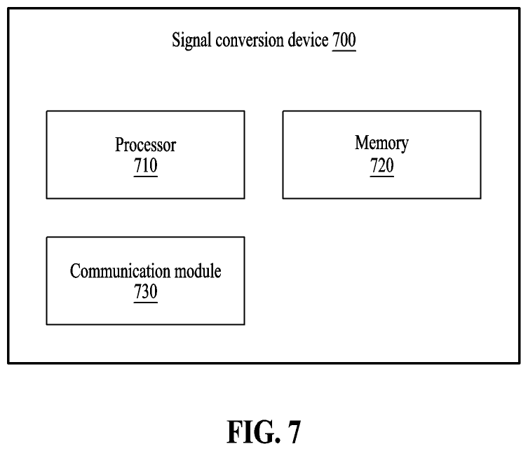

FIG. 7 is a block diagram illustrating a configuration of a signal conversion device that performs a signal conversion method, according to an embodiment.

Referring to FIG. 7, a signal conversion device 700 may include a processor 710, a memory 720, and a communication module 730. Here, the signal conversion device 700 may perform an operation to convert a signal as the signal conversion method described with reference to FIGS. 1 to 6, and the signal conversion device 700 may be a user terminal in which an application or a program related to the signal conversion method is running or installed.

The memory 720 may be connected to the processor 710 and may store instructions executable by the processor 710, data to be computed by the processor 710, or data processed by the processor 710. The memory 720 may include a non-transitory computer-readable medium, for example, high-speed random-access memory (RAM), and/or a non-volatile computer-readable storage medium, for example, at least one disk storage device, a flash memory device, or another non-volatile solid-state memory device.

The communication module 730 may support establishment of a direct (e.g., wired) communication channel or a wireless communication channel between the signal conversion device 700 and an external electronic device and may support communication through the established communication channel. The communication module 730 may include one or more communication processors that are operable independently of the processor 710 (e.g., an application processor) and that support direct (e.g., wired) communication or wireless communication. The communication module 730 may include an RIS including a plurality of unit cells, of which a reflection characteristic is variable, arranged horizontally or vertically. Descriptions of the unit cells and the RIS may be the same as the descriptions of the unit cells and the RISs given above with reference to FIGS. 1 to 6.

The processor 710 may control the signal conversion device 700 to perform one or more operations related to the operation of the signal conversion device 700 described herein.

For example, the processor 710 may control the signal conversion device 700 to receive a reflection coefficient of an RIS and an input signal according to a sample time, select a reflection coefficient of an RIS optimized for the sample time, and generate a modulation signal by applying the selected reflection coefficient of the RIS to the input signal.

For example, the processor 710 may control the signal conversion device 700 to generate a random entity population for a reflection coefficient of an RIS, select an entity having a highest similarity to a frequency of a target signal when a reflection coefficient of the RIS among reflection coefficients of the RIS in the random entity population is applied to the input signal at the sample time, determine whether a selected reflection coefficient entity of the RIS satisfies a threshold value, and, when the selected reflection coefficient entity of the RIS satisfies the threshold value, select a reflection coefficient of the RIS optimized for the sample time.

For example, when the selected reflection coefficient entity of the RIS does not satisfy the threshold value, the processor 710 may repeat crossing entities of reflection coefficients of the RIS in the random entity population, generating a new entity population through generating a mutant entity of an entity of the reflection coefficients of the RIS in the random entity population, and selecting an entity having the highest similarity to the frequency of the target signal when the reflection coefficient of the RIS among reflection coefficients of the RIS in the new entity population is applied to the input signal.

The signal conversion device 700 may further include a function generator that may apply appropriate voltage, by controlling the reflection coefficient of the RIS included in the communication module 730, to control a reflection magnitude and a reflection phase in real time.

The components described in the embodiments may be implemented by hardware components including, for example, at least one digital signal processor (DSP), a processor, a controller, an application-specific integrated circuit (ASIC), a programmable logic element, such as a field programmable gate array (FPGA), other electronic devices, or combinations thereof. At least some of the functions or the processes described in the embodiments may be implemented by software, and the software may be recorded on a recording medium. The components, the functions, and the processes described in the embodiments may be implemented by a combination of hardware and software.

The examples described herein may be implemented using hardware components, software components, and/or combinations thereof. A processing device may be implemented using one or more general-purpose or special-purpose computers, such as, for example, a processor, a controller, an arithmetic logic unit (ALU), a DSP, a microcomputer, an FPGA, a programmable logic unit (PLU), a microprocessor or any other device capable of responding to and executing instructions in a defined manner. The processing device may run an operating system (OS) and one or more software applications that run on the OS. The processing device may also access, store, manipulate, process, and create data in response to execution of the software. For purpose of simplicity, the description of a processing device is used as singular. However, one of ordinary skill in the art will appreciate that a processing device may include multiple processing elements and/or multiple types of processing elements. For example, a processing device may include a plurality of processors, or a single processor and a single controller. In addition, a different processing configuration is possible, such as one including parallel processors.

The software may include a computer program, a piece of code, an instruction, or some combination thereof, to independently or collectively instruct or configure the processing device to operate as desired. The software and/or data may be permanently or temporarily embodied in any type of machine, component, physical or virtual equipment, or computer storage medium or device for the purpose of being interpreted by the processing device or providing instructions or data to the processing device. The software may also be distributed over network-coupled computer systems so that the software is stored and executed in a distributed fashion. The software and data may be stored in a non-transitory computer-readable recording medium.

The methods according to the above-described examples may be recorded in non-transitory computer-readable media including program instructions to implement various operations of the above-described examples. The media may also include the program instructions, data files, data structures, and the like alone or in combination. The program instructions recorded on the media may be those specially designed and constructed for the examples, or they may be of the kind well-known and available to those having skill in the computer software arts. Examples of non-transitory computer-readable media include magnetic media such as hard disks, floppy disks, and magnetic tape; optical media such as compact disc read-only memory (CD-ROM) and a digital versatile disc (DVD); magneto-optical media such as floptical disks; and hardware devices that are specially configured to store and perform program instructions, such as read-only memory (ROM), RAM, flash memory, and the like. Examples of program instructions include both machine code, such as those produced by a compiler, and files containing higher-level code that may be executed by the computer using an interpreter.

The above-described hardware devices may be configured to act as one or more software modules in order to perform the operations of the above-described examples, or vice versa.

Although the examples have been described with reference to the limited number of drawings, it will be apparent to one of ordinary skill in the art that various technical modifications and variations may be made in the examples without departing from the spirit and scope of the claims and their equivalents. For example, suitable results may be achieved if the described techniques are performed in a different order, and/or if components in a described system, architecture, device, or circuit are combined in a different manner and/or replaced or supplemented by other components or their equivalents.

Therefore, other implementations, other examples, and equivalents to the claims are also within the scope of the following claims.

What is claimed is:

1. A signal conversion method for generating a modulation signal, the signal conversion method comprising:
receiving an input signal and a reflection coefficient of a reconfigurable intelligent surface (RIS) according to a sample time;
selecting an optimized reflection coefficient of the RIS corresponding to the sample time; and
generating the modulation signal by applying the optimized reflection coefficient of the RIS to the input signal.

2. The signal conversion method claim 1, wherein the selecting of the optimized reflection coefficient of the RIS comprises:
generating a random entity population for the reflection coefficient of the RIS and selecting, from among reflection coefficients of the RIS in the random entity population, a reflection coefficient entity having a highest similarity to a frequency of a target signal when the reflection coefficient of the RIS is applied to the input signal at the sample time;
determining whether the selected reflection coefficient entity of the RIS satisfies a threshold value; and
selecting the reflection coefficient of the RIS optimized for the sample time based on the selected reflection coefficient entity of the RIS, when the selected reflection coefficient entity of the RIS satisfies the threshold value.

3. The signal conversion method of claim 2, wherein, when the selected reflection coefficient entity of the RIS does not satisfy the threshold value, the selecting of the optimized reflection coefficient of the RIS further comprises:
crossing reflection coefficient entities of the RIS in the random entity population;
generating a new entity population through generating a mutant entity of an entity of the reflection coefficients of the RIS in the random entity population; and
selecting, from among reflection coefficients of the RIS in the new entity population, an entity having a highest similarity to the frequency of the target signal, when the reflection coefficient of the RIS is applied to the input signal.

4. The signal conversion method of claim 2, wherein the reflection coefficient entity of the RIS comprises:
information on a reflection magnitude coefficient of the modulation signal at the sample time and a reflection phase coefficient of the modulation signal at the sample time.

5. The signal conversion method of claim 1, wherein the selecting of the optimized reflection coefficient of the RIS comprises:
selecting the reflection coefficient of the RIS optimized for the sample time based on a look-up table.

6. A signal conversion device that generates a modulation signal, the signal conversion device comprising:
a processor;
at least one memory configured to store instructions to be executed by the processor; and
a communication module comprising a reconfigurable intelligent surface (RIS) comprising a plurality of unit cells, of which a reflection characteristic is variable, arranged horizontally or vertically,
wherein, when the instructions are executed by the processor, the processor is configured to:
receive an input signal and a reflection coefficient of a reconfigurable intelligent surface (RIS) according to a sample time;
select a reflection coefficient of the RIS optimized for the sample time; and
generate the modulation signal by applying the selected reflection coefficient of the RIS to the input signal.

7. The signal conversion device of claim 6, wherein the processor is further configured to:
generate a random entity population for the reflection coefficient of the RIS;
select, from among reflection coefficients of the RIS in the random entity population, a reflection coefficient entity having a highest similarity to a frequency of a target signal when the reflection coefficient of the RIS is applied to the input signal at the sample time;
determine whether the selected reflection coefficient entity of the RIS satisfies a threshold value; and
select the reflection coefficient of the RIS optimized for the sample time based on the selected reflection coefficient entity of the RIS, when the selected reflection coefficient entity of the RIS satisfies the threshold value.

8. The signal conversion device of claim 7, wherein the processor is further configured to repeat, when the selected reflection coefficient entity of the RIS does not satisfy the threshold value:
crossing reflection coefficient entities of the RIS in the random entity population;
generating a new entity population through generating a mutant entity of an entity of the reflection coefficients of the RIS in the random entity population; and
selecting, from among reflection coefficients of the RIS in the new entity population, an entity having a highest similarity to the frequency of the target signal, when the reflection coefficient of the RIS is applied to the input signal.

9. The signal conversion device of claim 7, wherein the reflection coefficient entity of the RIS comprises:
information on a reflection magnitude coefficient of the modulation signal at the sample time and a reflection phase coefficient of the modulation signal at the sample time.

10. The signal conversion device of claim 6, wherein the processor is further configured to:
select the reflection coefficient of the RIS optimized for the sample time based on a look-up table.

11. A cell comprising:
a first conductive layer;
a first dielectric substrate positioned at a lower end of the first conductive layer;
a second conductive layer positioned below the first dielectric substrate;
a second dielectric substrate positioned at a lower end of the second conductive layer; and
a conductor positioned at a lower end of the second dielectric substrate,
wherein the first conductive layer comprises:
a 1-1 conductor comprising a first diode and a first capacitor and arranged in a first direction; and
a 1-2 conductor arranged in a second direction perpendicular to the first direction,
wherein the 1-1 conductor and the 1-2 conductor are configured to be connected through first inductors, and
wherein the second conductive layer comprises:
a 2-1 conductor comprising a second diode and a second capacitor and arranged in the first direction; and
a 2-2 conductor arranged in the second direction perpendicular to the first direction,
wherein the 2-1 conductor and the 2-2 conductor are configured to be connected through second inductors.

12. The cell of claim 11, wherein
a pattern of the second conductive layer is identical to a pattern of the first conductive layer.

13. The cell of claim 11, wherein
a capacitance of the second capacitor included in the second conductive layer is different from a capacitance of the first capacitor included in the first conductive layer.

14. The cell of claim 11, wherein
voltage applied to the second diode included in the second conductive layer is different from voltage applied to the first diode included in the first conductive layer.

15. The cell of claim 11, wherein
a capacitance of the first diode changes depending on voltage applied to the first diode.

16. The cell of claim 11, wherein
a capacitance of the second diode changes depending on voltage applied to the second diode.

17. A reconfigurable intelligent surface (RIS) comprising a plurality of cells,
wherein each of the cells corresponds to the cell according to claim 11.

18. The RIS of claim 17, wherein a reflection coefficient of the RIS comprises:
information on a reflection magnitude coefficient of a modulation signal and a reflection phase coefficient of the modulating signal.
